(19) United States
(12) Patent Application Publication
(10) Pub. No.: US 2014/0310703 A1
(43) Pub. Date: Oct. 16, 2014

(54) MULTI-MACHINE DEPLOYMENT AND CONFIGURATION OF MULTI-TIERED APPLICATIONS

(71) Applicant: Microsoft Corporation, Redmond, WA (US)

(72) Inventors: Lidiane Pereira de Souza, Middleton, MA (US); Kristofer Hellick Reierson, Acton, MA (US); Matthew R. Yandek, Boston, MA (US)

(73) Assignee: Microsoft Corporation, Redmond, WA (US)

(21) Appl. No.: 14/203,081

(22) Filed: Mar. 10, 2014

Related U.S. Application Data
(63) Continuation of application No. 12/973,904, filed on Dec. 21, 2010, now abandoned.

(51) Int. Cl. G06F 9/445

(52) U.S. Cl. CPC G06F 8/61
USPC 717/177

(57) ABSTRACT

Technologies are described herein for deploying and configuring a multi-tiered application to multiple computers. A selection of one or more application packages from multiple available application packages is received. Each of the selected application packages may correspond to one of multiple deployment configurations. The selected application packages may form the multi-tiered application. A union operation is performed on the multiple deployment configurations to generate a merged deployment configuration. A deployment workflow for deploying and configuring the selected application packages to the multiple computers is generated. The selected application packages are deployed to the multiple computers over a network according to the deployment workflow and the merged deployment configuration.

### CROSS REFERENCE TO RELATED APPLICATIONS

This application is a continuation of U.S. application Ser. No. 12/973,904 filed Dec. 21, 2010 entitled “Multi-Machine Deployment and Configuration of Multi-Tiered Applications,” which is incorporated herein by reference.

### BACKGROUND

Generally, application virtualization decouples applications from an operating system and enables the applications to run as network services. In conventional operating system (“OS”) environments, applications install their settings onto a host operating system, typically altering critical system settings such as registry files and application configuration settings. Sometimes other applications' settings are overwritten, potentially causing these other applications to malfunction or break down.

In virtualized application environments, each virtualized application has its own set of configurations and runs without any installation within a virtual run-time abstraction layer on a client computer. As a result, dependencies or effects on the configuration of the OS are minimized. Further, because the virtualized applications still execute locally, they can run with full performance, functionality, and access to local services (e.g., attached printers, network drives, etc.).

In an illustrative virtualized application implementation, a management system creates an application package, which is a self-contained environment containing various files for executing a virtualized application. The management system then deploys the application package to computers, which can execute the application package through a virtual run-time abstraction layer without installing the application package. Because the application package is not installed on the client computer, the management system can also easily update the application package and remove the application package as needed or requested.

Conventional application packages are typically designed for execution on a single computer. While this limitation may be acceptable for desktop virtualization solutions, server applications can have multiple components that execute on multiple server computers operating in a cluster. The cluster of server computers may also need to communicate with each other to perform various tasks. As a result, conventional application packages may not be designed to handle the various challenges associated with deploying virtualized applications on multiple server computers.

It is with respect to these and other considerations that the disclosure made herein is presented.

### SUMMARY

Technologies are described herein for deploying and configuring a multi-tiered application to multiple computers. The multi-tiered application may include multiple individual applications. A deployment management system may be configured to receive user selections of one or more application packages from multiple available application packages. The selected application packages may form the multi-tiered application. The deployment management system may also be configured to receive user selections of various deployment configuration settings and generate a deployment workflow based, at least in part, on the deployment configuration settings. The deployment management system may further be configured to perform a union operation on deployment configurations corresponding to the selected application packages in order to generate a merged deployment configuration.

When the deployment management system generates the merged deployment configuration and the deployment workflow, the deployment management system may be configured to deploy the selected application packages to the multiple computers. The deployment management system may select the multiple computers from multiple available computers specified by the deployment workflow based on suitable load balancing techniques. When the deployment management system deploys the selected application packages to the multiple computers, the deployment management system may be configured to perform monitoring and recovery procedures according to monitoring and recovery settings specified by the deployment workflow.

In some example technologies, a method is configured to deploy and configure a multi-tiered application to multiple computers. According to the method, a selection of one or more application packages from multiple available application packages is received. Each of the selected application packages may correspond to one of multiple deployment configurations. The selected application packages may form the multi-tiered application. A union operation is performed on the multiple deployment configurations to generate a merged deployment configuration. A deployment workflow for deploying and configuring the selected application packages to the multiple computers is generated. The selected application packages are deployed to the multiple computers over a network according to the deployment workflow and the merged deployment configuration.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a network architecture for deploying and configuring a multi-tiered application to multiple computers, in accordance with some embodiments;

FIG. 2 is a flow diagram illustrating a method for deploying and configuring a multi-tiered application to multiple computers, in accordance with some embodiments; and

FIG. 3 is a computer architecture diagram showing an illustrative computer hardware architecture for a computing system capable of implementing the embodiments presented herein.

### DETAILED DESCRIPTION

The following detailed description is directed to technologies for deploying and configuring a multi-tiered application to multiple computers. Through the utilization of the technologies and concepts presented herein, a deployment management system can be adapted to manage deployment of multiple application packages to multiple computers. The multiple application packages may correspond to the multi-tiered application. The multi-tiered application may include multiple individual applications. An administrator or other personnel can access the deployment management system and select one or more application packages, each of which may correspond to particular tier of a multi-tier server application. Each of the application packages may correspond to a particular deployment configuration.

Through the deployment management system, the administrator may also establish deployment configuration settings associated with the selected application packages. In particular, the administrator may define roles of the selected application packages, specify any expected interaction between the selected application packages, and specify any monitoring and recovery settings associated with the selected application packages. The administrator may also specify an order in which the selected application packages should be deployed.

When the administrator selects the application packages and establishes the deployment configuration settings, the deployment management system may generate a deployment workflow and a merged deployment configuration. The deployment workflow may contain instructions specifying the selected application packages that should be deployed. The deployment workflow may also specify the initial configuration the selected application packages, as well as the monitoring and recovery procedures associated with the selected application packages. The deployment workflow may further include information regarding a cluster of available computers to which the selected application packages can be deployed.

The deployment management system may also generate a merged deployment configuration. The deployment management system may generate the merged deployment configuration by performing a union operation on the relevant deployment configurations corresponding to the selected application packages. The merged deployment configuration may contain distinct elements from the relevant deployment configurations.

When the deployment workflow and the merged deployment configuration have been generated, the deployment management system may deploy and configure the selected application packages according to the deployment workflow and the merged configuration. In particular, the deployment management system may deploy the selected application packages in the order specified in the deployment workflow and configure the deployed application packages according to the initial configuration in the deployment workflow. The deployment management system may deploy the selected application packages to one or more computers in the cluster of available computers according to suitable load balancing techniques. The deployment management system may deploy the selected application packages for various reasons. For example, a server application may be distributed to multiple machines because each application tier of the server application may reside on special purposed machines (e.g., a database machine for storage, a high performance machine for computational layers, etc.).

The deployment management system may also perform monitoring and recovering procedures according to the monitoring and recovering settings in the deployment workflow. The administrator can also dynamically adjust the deployment workflow in order to facilitate changes to the monitoring and recovery settings. Through the various embodiments described herein, the deployment management system may deploy and configure the selected application packages to multiple computers without any additional input from the administrator beyond the initial setup. The deployment workflow and the merged deployment configuration may be stored at a centralized location.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

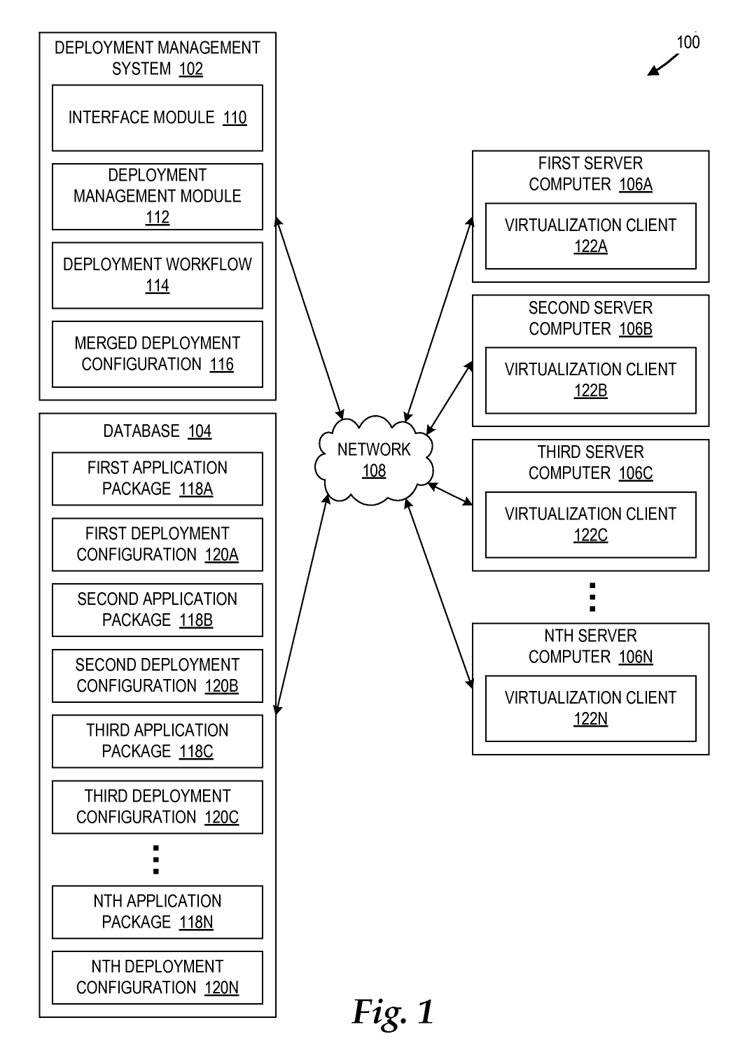

In the following detailed description, references are made to the accompanying drawings that form a part hereof, and which are shown by way of illustration, specific embodiments, or examples. Referring now to the drawings, in which like numerals represent like elements through the several figures, a computing system and methodology for deploying and configuring a multi-tiered application to multiple computers will be described. In particular, FIG. 1 illustrates a network architecture 100 for deploying and configuring a multi-tiered application to multiple computers, in accordance with some embodiments. The network architecture 100 may include a deployment management system 102, a database 104, and a cluster of computers 106A-106N, which are communicatively coupled via a network 108. The cluster of computers 106A-106N may be collectively referred to as a cluster of computers 106. Some examples of the network 108 may include a local area network (“LAN”), a wide area network (“WAN”), and the Internet.

The deployment management system 102 may include an interface module 110, a deployment management module 112, a deployment workflow 114, and a merged deployment configuration 116. The database 104 may include multiple application packages, including a first application package 118A, a second application package 118B, a third application package 118C, and an Nth application package 118N. The application packages 118A-118N may be collectively referred to as application packages 118.

The database 104 may also include a first deployment configuration 120A, a second deployment configuration 120B, a third deployment configuration 120C, and an Nth deployment configuration 120N. The first deployment configuration 120A, the second deployment configuration 120B, the third deployment configuration 120C, and the Nth deployment configuration 120N may correspond to the first application package 118A, the second application package 118B, the third application package 118C, and the Nth application package 118N, respectively. The deployment configurations 120A-120N may be collectively referred to as deployment configurations 120. In some embodiments, the cluster of computers 106 may include multiple server computers, which provide services to client computers (not shown) over the network 108. The cluster of computers 106 may include virtualization clients 122A-122N. The virtualization clients 122A-122N may be collectively referred to as virtualization clients 122.

In an illustrative implementation, a sequencer (not shown) may be configured to monitor and record interactions between a given application and the OS during installation and execution of the application. The sequencer may analyze particular OS components, such as dynamic linked libraries, that the application utilizes or depends upon. Based on these specific interactions, the sequencer can generate an application package, such as the application packages 118. In particular, the sequencer may convert application data of a traditionally-installed application into a format associated with the application package. When the application package is deployed to a computer, a virtualization client, such as the virtualization clients 122, installed on the computer may be configured to execute the application package without installation in self-contained virtual environment.

The application packages 118 may be deployed in accordance with their corresponding deployment configurations 120. The deployment configurations 120 may specify various rules for deploying the corresponding application packages 118 to the computers 106, thereby enabling the computers 106 to execute the application packages 118 via the virtualization clients 122. For example, the deployment configurations 120 may create and maintain a virtual file system, virtual registry, and/or other aspects of the virtual environment under which the application packages 118 operate. Each of the deployment configurations 120 may have specific configuration settings that are not present in other deployment configurations. Further, each of the deployment configurations 120 may be located at different locations (e.g., different remote databases) and have no link or awareness of other deployment configurations 120.

When the application packages 118 are independent from each other, which is typically the case with desktop application virtualization, having the separate deployment configurations 120 may generally be acceptable. However, such separate deployment configurations 120 may be unacceptable with respect to deploying server applications, and in particular, server applications having multiple tiers. For example, a server application may have a database backend tier, a web services frontend tier, and a custom middleware tier that operates between the database backend tier and the web services frontend tier. Other suitable tiers may be similarly defined. These tiers may need to communicate with each other in order to provide functionality of the server application. An administrator may desire to have a separate application package for each tier. Each application package can then be deployed to one or more computers in the cluster of computers 106 according to suitable load-balancing techniques. In this way, the administrator can utilize the cluster of computers 106 in order to optimize resource utilization, maximize throughput, minimize response time, and avoid overload.

In an illustrative implementation, a separate application package and corresponding deployment configuration may be created for each tier. The deployment configurations may have no link or awareness of each other. Thus, if the application packages need to be deployed in a particular order, an administrator may manually deploy the application packages in that order. Further, the administrator may manually configure the deployed application packages to interact with each other. Managing the deployment and configuration of each separate application package can be unduly time-consuming and challenging for the administrator. The complexity of deploying a multi-tier server application can grow further as the number of tiers increase or with the deployment of multiple instances of certain tiers.

Various embodiments described herein provide the deployment management system 102, which is configured to deploy and configure a multi-tiered application to multiple computers, such as the cluster of computers 106. The administrator may access the interface module 110 in order to select the application packages from the application packages 118 that belong to a virtualized server application. Any number of application packages may be selected. In an illustrative example, the administrator may select the first application package 118A, the second application package 118B, and the third application package 118C. The first application package 118A may correspond to a first tier of the virtualized server application, the second application package 118B may correspond to a second tier of the virtualized server application, and the third application package 118C may correspond to a third tier of the virtualized server application.

In addition to specifying that the first application package 118A, the second application package 118B, and the third application package 118C belong to the virtual server application, the administrator can utilize the interface module 110 to specify various deployment configuration settings associated with the selected application packages. In particular, the administrator may utilize the interface module 110 to specify roles of the first application package 118A, the second application package 118B, and the third application package 118C. The administrator can further utilize the interface module 110 to specify any expected interaction between the first application package 118A, the second application package 118B, and the third application package 118C. The expected interaction may include various links and/or dependencies between aspects of the first application package 118A, the second application package 118B, and the third application package 118C. Continuing the illustrative example, the administrator may specify that the first application package 118A corresponds to a database backend tier, the second application package 118B corresponds to a custom middleware tier, and the third application package 118C corresponds to a web services frontend tier. The administrator may also specify interaction between the first application package 118A (i.e., the database backend tier in this example) and the second application package 118B (i.e., the custom middleware tier in this example), as well as interaction between the second application package 118B and the third application package 118C (i.e., the web services frontend tier in this example).

The administrator can also utilize the interface module 110 to specify an order in which the deployment management module 112 deploys first application package 118A, the second application package 118B, and the third application package 118C. Continuing the illustrative example, the administrator may specify that the first application package 118A is deployed before the second application package 118B and that the second application package 118B is deployed before the third application package 118C. The administrator may desire that certain application packages be deployed before or after other application packages due to dependencies between the application packages or other suitable criteria.

The administrator can also utilize the interface module 110 to specify monitoring and recovery settings corresponding to monitoring and recovery procedures. The deployment management module 112 may perform the monitoring and recovery procedures associated with the selected application packages. In one example, the first application package 118A may be deployed to the first computer 106A, and the second application package 118B may be deployed to the second computer 106B. If the first computer 106A is taken down for maintenance or suffers a critical malfunction, the second application package 118B may no longer be able to communicate with the first application package 118A. The administrator may utilize the interface module 110 to establish a recovery procedure that requests the deployment management module 112 redeploy an application package when a computer that executes the application package suffers a failure. In this example, the deployment management module 112 may redeploy the first application package 118A to the Nth computer 106N. Upon redeploying the first application package 118A to the Nth computer 106N, the deployment management module 112 may configure the second application package 118B to communicate with the Nth computer 106N instead of the first computer 106A.

In another example, the second application package 118B and the third application package 118C may be configured to access a shared resource, such as a shared remote database having an original name. The deployment management module 112 may initially deploy the second application package 118B and the third application package 118C to the second computer 106B and the third computer 106C, respectively. Upon deploying the second application package 118B and the third application package 118C, the deployment management module 112 may configure the second application package 118B and the third application package 118C to access the shared remote database through the original name.

During execution of the second application package 118B and the third application package 118C, the original name of the shared remote database may be changed to an alternate name. The administrator may utilize the interface module 110 to specify a monitoring procedure whereby the deployment management module 112 monitors changes to configuration settings with respect to the shared remote database. In this example, the deployment management module 112 may identify that the original name of the shared remote database has changed to the alternate name. The deployment management module 112 may then propagate the change to the alternate name to the second computer 106B and third computer 106C. In this way, the deployment management module 112 can reconfigure the second application package 118B and the third application package 118C to access the shared remote database under the alternate name instead of the original name.

When the administrator establishes the deployment configuration settings, the interface module 110 may generate the deployment workflow 114. The deployment workflow 114 may contain instructions specifying the selected application packages, such as the first application package 118A, the second application package 118B, and the third application package 118C, that the deployment management module 112 should deploy. The deployment workflow 114 may also specify the deployment configuration settings, including an initial configuration of the deployed application packages, as well as the monitoring and recovery settings associated with the deployed application packages. The deployment workflow 114 may further include information regarding the cluster of computers 106. In this way, the deployment management module 112 can select appropriate computers from the cluster of computers 106 to deploy the selected application packages.

The interface module 110 may also generate the merged deployment configuration 116. The interface module 110 may generate the merged deployment configuration 116 by performing a union operation on the relevant deployment configurations corresponding to the selected application packages. The merged deployment configuration 116 may contain distinct elements from the relevant deployment configurations. For example, if the selected application packages include the first application package 118A, the second application package 118B, and the third application package 118C, the relevant deployment configurations may include the first deployment configuration 120A, the second deployment configuration 120B, and the third deployment configuration 120C.

When the deployment workflow 114 and the merged deployment configuration 116 have been generated, the deployment management module 112 may deploy and configure the selected application packages according to the deployment workflow 114 and the merged deployment configuration 116. In particular, the deployment management module 112 may deploy the selected application packages in the order specified in the deployment workflow 114 and configure the deployed application packages according to the initial configuration in the deployment workflow 114. The deployment management module 112 may propagate the common configuration elements from the deployment management module 112 to the selected application packages making up the multi-tiered deployment. The deployment management module 112 may deploy the selected application packages to one or more computers in the cluster of computers 106 according to suitable load balancing techniques.

The deployment management module 112 may also perform monitoring and recovering procedures according to the monitoring and recovering settings in the deployment workflow 114. The administrator can also dynamically adjust the deployment workflow 114 in order to facilitate changes to the monitoring and recovery settings. Through the various embodiments described herein, the deployment management module 112 may deploy and configure the selected application packages to multiple computers without any additional input from the administrator beyond the initial setup. The deployment workflow 114 and the merged deployment configuration 116 may be stored at a centralized location.

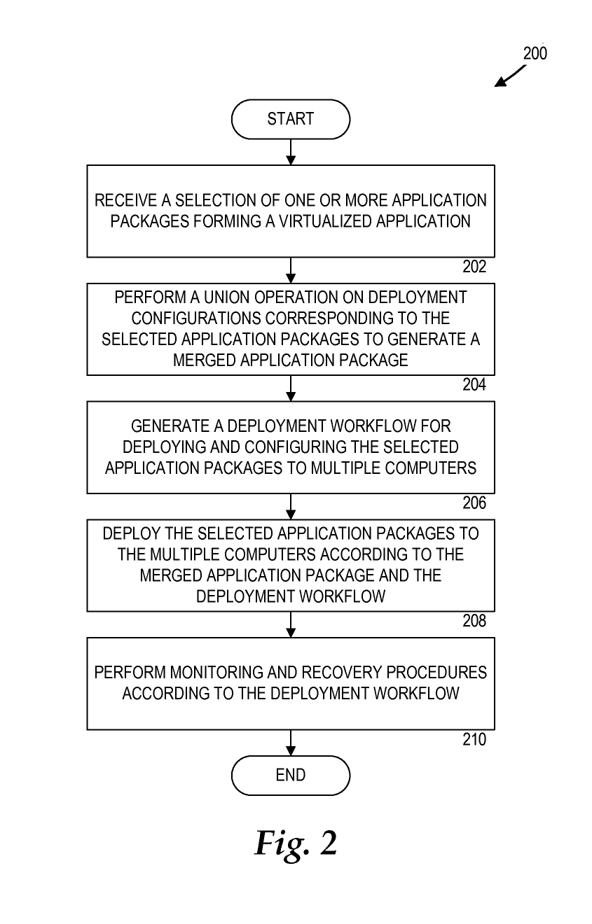

Referring now to FIG. 2, additional details regarding the operation of the deployment management system 102. In particular, FIG. 2 is a flow diagram illustrating a method for deploying and configuring a multi-tiered application to multiple computers, in accordance with some embodiments. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In FIG. 2, a routine 200 begins at operation 202, where the deployment management system 202 receives a selection of one or more application packages, such as the application packages 118, forming a multi-tiered application. In some embodiments, an administrator or other suitable personnel may access the interface module 110 to select the application packages. The application packages may be selected from multiple available application packages. Each of the application packages may be associated with a corresponding one of multiple deployment configurations. Each of the deployment configurations may specify a virtual environment within which a corresponding one of the application packages is executed. When the deployment management system 202 receives a selection of one or more application packages, the routine 200 proceeds to operation 204.

At operation 204, the deployment management system 202 performs a union operation on the relevant deployment configurations corresponding to the selected application packages. The union operation may select distinct elements from each of the relevant deployment configurations. By performing the union operation on the relevant deployment configurations, the deployment management system 202 may generate a merged application package, such as the merged deployment configuration 116. When the deployment management system 202 performs a union operation on the relevant deployment configurations corresponding to the selected application packages, the routine 200 proceeds to operation 206.

At operation 206, the deployment management system 202 generates a deployment workflow, such as the deployment workflow 114, for deploying and configuring the selected application packages to multiple computers. Through the interface module 110, the administrator may specify various deployment configuration settings. In a first example, the administrator may specify roles of the selected application packages. In a second example, the administrator may specify expected interaction between the selected application packages. In a third example, the administrator may specify an order in which the selected application packages should be deployed. In a fourth example, the administrator may specify monitoring and recovery settings corresponding to the monitoring and recovery procedures. The deployment workflow may also specify information regarding multiple available computers. When the deployment management system 202 generates the deployment workflow for deploying and configuring the selected application packages to multiple computers, the routine 200 proceeds to operation 208.

At operation 208, the deployment management system 202 deploys the selected application packages to the multiple computers according to the merged application package and the deployment workflow. The deployment management system 202 may deploy the selected application packages in the order specified in the deployment workflow. The deployment management system 202 may configure the deployed application packages according to their roles and their expected interaction with each other as specified in the deployment workflow. The deployment management system 202 may select the multiple computers from the multiple available computers specified in the deployment workflow according to suitable load balancing techniques. When the deployment management system 202 deploys the selected application packages to the multiple computers according to the merged application package and the deployment workflow, the routine 200 proceeds to operation 210.

At operation 210, the deployment management system 202 performs monitoring and recovery procedures according to monitoring and recovering settings specified in the deployment workflow. The monitoring and recovery procedures may monitor various configuration settings associated with the deployed application packages and perform certain actions in light of certain changes to the configuration settings. The monitoring and recovery procedures may also monitor the health of various systems associated with the deployed application packages and perform recovery procedures in light of changes to the health of the monitored systems. When the deployment management system 202 performs monitoring and recovery procedures according to monitoring and recovering settings specified in the deployment workflow, the routine 200 may either repeat (e.g., periodically, continuously, or on demand as needed) or terminate.

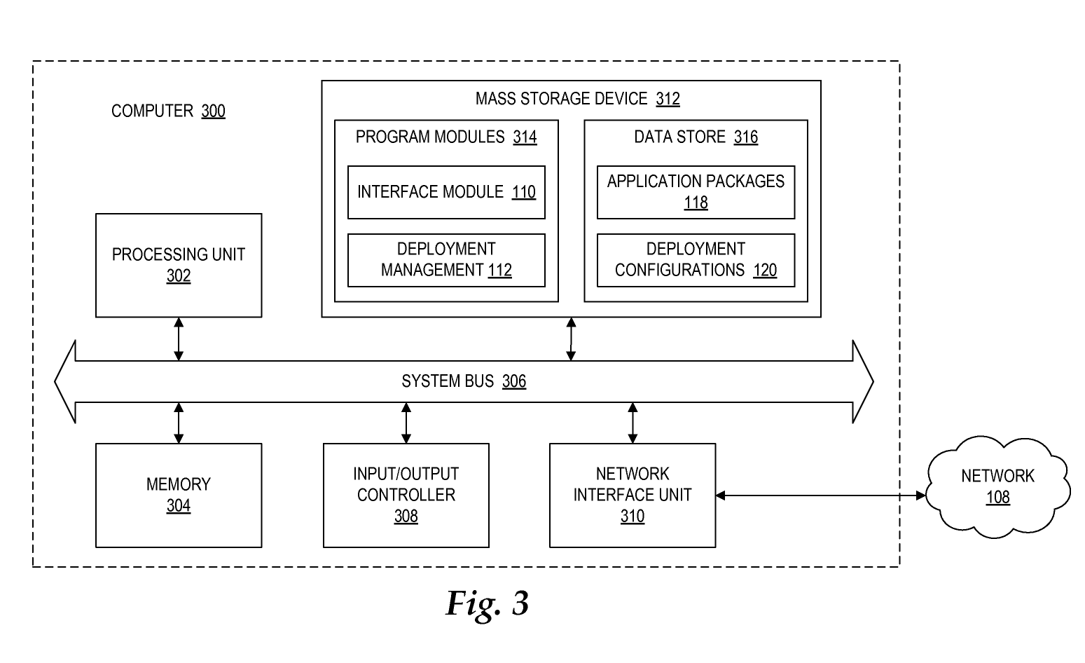

Turning now to FIG. 3, an example computer architecture diagram showing a computer 300 is illustrated. Examples of the computer 300 may include the deployment management system 102 and the computers 106. The computer 300 may include a central processing unit 302, a system memory 304, and a system bus 306 that couples the memory 304 to the central processing unit 302. The computer 300 may further include a mass storage device 312 for storing one or more program modules 314 and a data store 316. Examples of the program modules 314 may include the interface module 110 and the deployment management module 112. An example of the data store 316 may include the database 104, which can store the application packages 118 and the deployment configurations 120. The mass storage device 312 may be connected to the processing unit 302 through a mass storage controller (not shown) connected to the bus 306. The mass storage device 312 and its associated computer-storage media may provide non-volatile storage for the computer 300. Although the description of computer-storage media contained herein refers to a mass storage device, such as a hard disk or CD-ROM drive, it should be appreciated by those skilled in the art that computer-storage media can be any available computer storage media that can be accessed by the computer 300.

By way of example, and not limitation, computer-storage media may include volatile and non-volatile, removable and non-removable media implemented in any method or technology for the non-transitory storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 300.

According to various embodiments, the computer 300 may operate in a networked environment using logical connections to remote computers through a network, such as the network 108. The computer 300 may connect to the network 108 through a network interface unit 310 connected to the bus 306. It should be appreciated that the network interface unit 310 may also be utilized to connect to other types of networks and remote computer systems. The computer 300 may also include an input/output controller 308 for receiving and processing input from a number of input devices (not shown), including a keyboard, a mouse, a microphone, and a game controller. Similarly, the input/output controller 308 may provide output to a display or other type of output device (not shown).

The bus 306 may enable the processing unit 302 to read code and/or data to/from the mass storage device 312 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 314 may include software instructions that, when loaded into the processing unit 302 and executed, cause the computer 300 to deploy and configure a multi-tiered application to multiple computers. The program modules 314 may also provide various tools or techniques by which the computer 300 may participate within the overall systems or operating environments using the components, flows, and data structures discussed throughout this description. For example, the program modules 314 may implement interfaces for deploying and configuring a multi-tiered application to multiple computers.

In general, the program modules 314 may, when loaded into the processing unit 302 and executed, transform the processing unit 302 and the overall computer 300 from a general-purpose computing system into a special-purpose computing system customized to deploy and configure a multi-tiered application to multiple computers. The processing unit 302 may be constructed from any number of transistors or other discrete circuit elements, which may individually or collectively assume any number of states. More specifically, the processing unit 302 may operate as a finite-state machine, in response to executable instructions contained within the program modules 314. These computer-executable instructions may transform the processing unit 302 by specifying how the processing unit 302 transitions between states, thereby transforming the transistors or other discrete hardware elements constituting the processing unit 302.

Encoding the program modules 314 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 314 may transform the physical state of the semiconductor memory, when the software is encoded therein. For example, the program modules 314 may transform the state of transistors, capacitors, or other discrete circuit elements constituting the semiconductor memory.

As another example, the computer-storage media may be implemented using magnetic or optical technology. In such implementations, the program modules 314 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that technologies for deploying and configuring a multi-tiered application to multiple computers are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A computer-implemented method for deploying and configuring a multi-tiered application to one or more computing devices, the method comprising computer-implemented operations for:
receiving a selection of one or more application packages from a plurality of available application packages, each of the selected application packages corresponding to one of a plurality of deployment configurations, wherein a deployment configuration of the plurality of deployment configurations is not linked to and is unaware of another deployment configuration of the plurality of deployment configurations, and wherein the one or more selected application packages form the multi-tiered application;
performing a union operation on the plurality of deployment configurations to generate a merged deployment configuration;
generating a deployment workflow for deploying and configuring the selected application packages to the one or more computing devices; and
deploying the selected application packages to the one or more computing devices over a network according to the deployment workflow and the merged deployment configuration.

2. The computer-implemented method of claim 1, further comprising computer-implemented operations for:
performing monitoring and recovery procedures associated with the deployed application packages according to the deployment workflow.

3. The computer-implemented method of claim 1, wherein generating a deployment workflow for deploying and configuring the selected application packages to the one or more computing devices comprises:
receiving a specification of roles of the selected application packages; and
generating the deployment workflow specifying the roles of the selected application packages.

4. The computer-implemented method of claim 1, wherein generating a deployment workflow for deploying and configuring the selected application packages to the one or more computing devices comprises:
receiving a specification of expected interaction between the selected application packages; and
generating the deployment workflow specifying the expected interaction between the selected application packages.

5. The computer-implemented method of claim 1, wherein generating a deployment workflow for deploying and configuring the selected application packages to the one or more computing devices comprises:
receiving a specification of an order in which the selected application packages should be deployed; and
generating the deployment workflow specifying the order in which the selected application packages should be deployed.

6. The computer-implemented method of claim 2, wherein generating a deployment workflow for deploying and configuring the selected application packages to the one or more computing devices comprises:
receiving a specification of monitoring and recovery settings corresponding to the monitoring and recovery procedures; and
generating the deployment workflow specifying the monitoring and recovery settings corresponding to the monitoring and recovery procedures.

7. The computer-implemented method of claim 6, further comprising computer-implemented operations for:
upon deploying the selected application packages to the one or more computing devices over the network according to the deployment workflow and the merged deployment configuration, receiving an adjustment of the monitoring and recovery settings; and
propagating the adjustment of the monitoring and recovering settings to the deployed application packages.

8. The computer-implemented method of claim 1, wherein the deployment workflow specifies information regarding one or more available computing devices; and wherein deploying the selected application packages to the one or more computing devices over a network according to the deployment workflow and the merged deployment configuration comprises selecting the one or more computing devices from the one or more of available computing devices according to load balancing techniques.

9. The computer-implemented method of claim 1, wherein the each of the deployment configurations specifies a virtual environment within which a corresponding one of the application packages is executed.

10. The computer-implemented method of claim 1, wherein the one or more computing devices comprises a plurality of server computers; and wherein the multi-tiered application comprises a virtualized server application.

11. A computer-readable storage medium having computer-executable instructions stored thereon which, when executed by a computer, cause the computer to deploy and configure a multi-tiered application to one or more computing devices by:
receiving a selection of one or more application packages from a plurality of available application packages, each of the selected application packages corresponding to one of a plurality of deployment configurations, wherein a deployment configuration of the plurality of deployment configurations is not linked to and is unaware of another deployment configuration of the plurality of deployment configurations, wherein the one or more selected application packages form the multi-tiered application;
performing a union operation on the plurality of deployment configurations to generate a merged deployment configuration;
generating a deployment workflow for deploying and configuring the selected application packages to the one or more computing devices;
deploying the selected application packages to the one or more computing devices over a network according to the deployment workflow and the merged deployment configuration.

12. The computer-readable storage medium of claim 11, wherein generating a deployment workflow for deploying and configuring the selected application packages to the one or more computing devices comprises:
receiving a specification of roles of the selected application packages; and
generating the deployment workflow specifying the roles of the selected application packages.

13. The computer-readable storage medium of claim 11, wherein generating a deployment workflow for deploying and configuring the selected application packages to the one or more computing devices comprises:
receiving a specification of expected interaction between the selected application packages; and
generating the deployment workflow specifying the expected interaction between the selected application packages.

14. The computer-readable storage medium of claim 11, wherein generating a deployment workflow for deploying and configuring the selected application packages to the one or more computing devices comprises:
receiving a specification of an order in which the selected application packages should be deployed; and
generating the deployment workflow specifying the order in which the selected application packages should be deployed.

15. The computer-readable storage medium of claim 11, having further computer-executable instructions stored thereupon for performing one or more monitoring and recovery procedures associated with the deployed application packages according to the deployment workflow, and wherein generating a deployment workflow for deploying and configuring the selected application packages to the one or more computing devices comprises:
receiving a specification of monitoring and recovery settings corresponding to the monitoring and recovery procedures; and
generating the deployment workflow specifying the monitoring and recovery settings corresponding to the monitoring and recovery procedures.

16. The computer-readable storage medium of claim 15, further comprising computer-implemented operations for:
upon deploying the selected application packages to the one or more computing devices over the network according to the deployment workflow and the merged deployment configuration, receiving an adjustment of the monitoring and recovery settings; and
propagating the adjustment of the monitoring and recovering settings to the deployed application packages.

17. The computer-readable storage medium of claim 11, wherein the deployment workflow specifies information regarding one or more a available computing devices; and wherein deploying the selected application packages to the one or more computing devices over a network according to the deployment workflow and the merged deployment configuration comprises selecting the one or more computing devices from the one or more available computing devices according to load balancing techniques.

18. A computer system, comprising:
a processor;
a memory communicatively coupled to the processor; and
a program module which executes in the processor from the memory and which, when executed by the processor, causes the computer system to deploy and configure a multi-tiered application to one or more computing devices by
receiving a selection of one or more application packages from a plurality of available application packages, each of the selected application packages corresponding to one of a plurality of deployment configurations, wherein a deployment configuration of the plurality of deployment configurations is not linked to and is unaware of another deployment configuration of the plurality of deployment configurations, wherein the selected application packages from the multi-tiered application, each of the deployment configurations specifying a virtual environment within which a corresponding one of the application packages is executed,
performing a union operation on the plurality of deployment configurations to generate a merged deployment configuration,
generating a deployment workflow for deploying and configuring the selected application packages to the one or more computing devices, and
deploying the selected application packages to the one or more computing devices over a network according to the deployment workflow and the merged deployment configuration.

19. The system of claim 18, wherein the program module further causes the computer system to deploy and configure the multi-tiered application to the one or more computing devices by:
selecting the one or more computing devices from a plurality of available computers according to load balancing techniques;
performing monitoring and recovery procedures associated with the deployed application packages according to the deployment workflow;
receiving a specification of roles of the selected application packages;
receiving a specification of expected interaction between the selected application packages;
receiving a specification of an order in which the selected application packages should be deployed;
receiving a specification of monitoring and recovery settings corresponding to the monitoring and recovery procedures; and
generating the deployment workflow specifying the roles of the selected application packages, the expected interaction between the selected application packages, the order in which the selected application packages should be deployed, and the monitoring and recovery settings corresponding to the monitoring and recovery procedures.

20. The system of claim 19, wherein the program module further causes the computer system to deploy and configure the multi-tiered application to one or more computing devices by:
upon deploying the selected application packages to the one or more computing devices over the network according to the deployment workflow and the merged deployment configuration, receiving an adjustment of the monitoring and recovery settings; and
propagating the adjustment of the monitoring and recovering settings to the deployed application packages.
